(19) United States
(12) Patent Application Publication
(10) Pub. No.: US 2009/0025652 A1
(43) Pub. Date: Jan. 29, 2009

(54) Deer repelling apparatus for small gardens

(75) Inventor: Chiou-Muh Jong, Ellicott City, MD (US)

Correspondence Address: Chiou-muh Jong, 11058 Dorsch Farm Road, Ellicott City, MD, 21042, US

(73) Assignee: Chiou-muh Jong, Ellicott City, MD (US)

(21) Appl. No.: 12/164,063

(22) Filed: Jun. 29, 2008

Related U.S. Application Data
(60) Provisional application No. 60/952,577, filed on Jul. 29, 2007.

(51) Int. Cl. A01K 15/00

(52) U.S. Cl. 119/720

(57) ABSTRACT

A handy device for repelling deer from destroying flowers and fruits in a small garden is invented. The scaring effect guaranteed to drive animals away is generated in two steps: the first one is to issue a sequence of multi-frequency ultrasonic waves toward the approaching animals detected by a sensor, followed by sudden expansion of a party blower like air expander. The pressured air for expanding air expander can be pressurized by an air pump or direct using of a pressurized air can.

### 1. CROSS-REFERENCE INFORMATION

The present application claims the priority to co-pending U.S. Provision patent application Ser. No. 60/952,577 entitled “Deer repelling apparatus for small gardens” filed on Jul. 29, 2007

### 2. FIELD OF THE INVENTION

The present invention relates to repelling of deer and other smaller animals from a small garden. More specifically, it relates to scaring animals away by firstly broadcasting ultrasound to annoy animals, followed by suddenly charging pressurized air into an involutely coiled air expander made of soft and light material.

### 3. BACKGROUND OF THE INVENTION

As more and more people choose to live in suburban area with bigger home sites, they get more threat of property damage from the migrating animals such as deer as well. It is commonly known that there is increasing damage and loss caused by the rising deer population, which, in search of food are migrating to populated suburban areas.

There is a need to deter animals, including domestic animals such as cats and dogs, together with many other animals from certain areas, but not hurt the animals in any way. Furthermore, there is a requirement to have a deterrent device for animals which does not harm the environment.

The ways to achieve deterring goal include spraying of specific chemicals in designated area, which is considered as a not environmental friendly way to do and the effect is deteriorating with increasing raining days. Using ultrasound, especially in specific generation pattern, is also a popular way to repel animals such as deer. U.S. Pat. Nos. 5,278,537, 5,418,518 and 5,602,523 are examples for such repelling system. The effectiveness, however, is generally not as good as desired.

A lot of attempts based on other schemes have also been proposed to repel animals to avoid damages. U.S. Pat. Nos. 5,009,192, 5,458,093 and 6,373,385 all provide devices which activate sprinklers when animals enter a certain area and provide several pulses of water until the animals move out of the area. Pulse type sprinklers have a definite tick noise as they move through an arc and these may be set up to be activated when an animal is detected in a specific area. They typically use solenoid valves to control the spray of water through sprinklers. These devices, although proved to be effective, have a big drawback that a connecting pipe is needed to supply pressurized tap water for activating the sprinklers. Such piping line lying on the lawn, unless buried under ground, is not only a nuisance for the landscape, but also a trap for human and machine to move on the lawn surface and in general is considered as a headache for homeowner in the lawn mowing season. In addition, such sprinkler repelling system is not useful to protect a small garden as it is difficult to find ideal location for installation, sprinkler spreads water to undesired area and inconvenient for small garden etc.

There are some devices for deterring small animals already exist in the markets. Most of these devices, however, are for indoor use. Ultrasound animal deterring devices are particularly common. Some devices use air blow noise to scare animals too. But one can concludes that all these devices never take advantages of deterring animals in two or more stages. The present invention, on the other hand, use two stages of scaring effect, achieved first by ultrasound and then by sudden expansion and noise of an air expander. By using two stages deterring mechanism, the synergy of scaring effect is uniquely created in the present invention.

### 4. SUMMARY OF THE INVENTION

To create maximum scaring effect yet no harm to animals, the present invention takes the advantage of deterring power of ultrasound and sudden expansion of a party blower like air expander to deter animals from invading a small garden. Although the ultrasound used in first stage deterrence may or may not repel animals away, it functions as a pre-warning mechanism, which in turn enhances the scaring effect from the sudden expansion of an air expander. The combination from such two successive scaring mechanisms will definitely drive animals away and the precious garden flowers can be saved.

### 5. BRIEF DESCRIPTION OF DRAWINGS

FIG. 1 shows a preferred implementation of current invention. The apparatus includes solar energy application, PIR sensor for detecting animals, ultrasound generation/broadcasting and a party blower like air expander for scaring animals.

### 6. DETAILED DESCRIPTION OF THE INVENTION

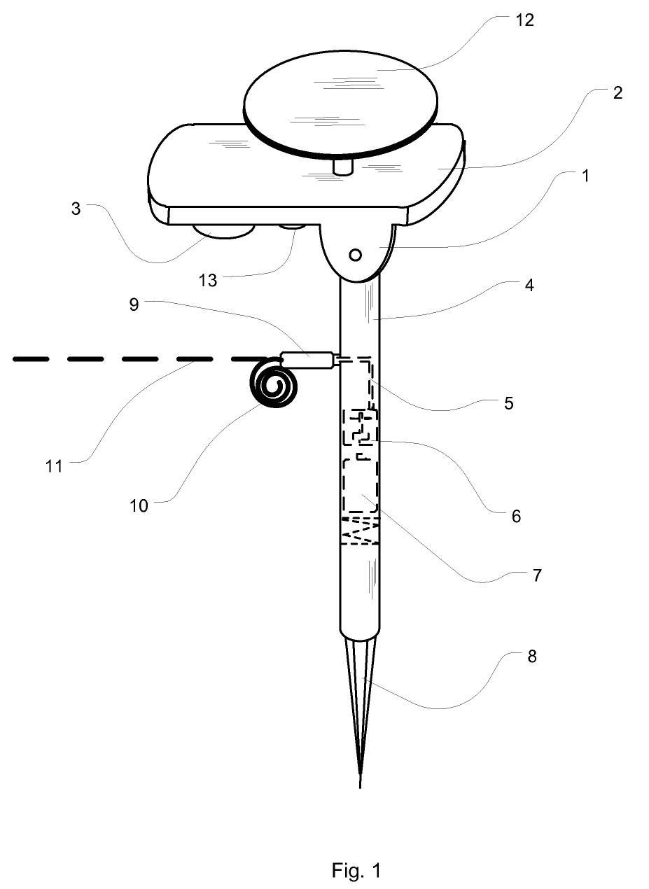

Referring to FIG. 1, a device 1 for preventing deer from eating flowers in a small garden is shown. Device 1 is equipped with a detecting sensor 2 with lens 3 underneath for detecting the existence of a deer inside the circular neighborhood of, say, 1 meter in radius. A PIR sensor with Fresnel lens 3 is used to detect approaching animals. In a preferred embodiment the lens is arranged to face downward such that the detecting area can be narrowed down to cover a small circular area where a precious blower bed or plant is to be protected. Upon detecting existing of deer and other animals, the ultrasound speaker 13 announces a series of different frequency ultrasound waves, which will in general warn the animals that they are in trouble area. In our test, the animals seem to get bigger shock by the sudden expansion of air expander 10 and the audible noise it creates prelude with an ultrasound than the case without. The air expander has a pipe 9 for introducing air and support the expander by inserting portion of it into main stem 4. In main stem 4, soft air tube 5 connects exit of air pump 6 and pipe 9 for exhausting air to the expander. Air expander 10 expands to be 11 when the pressurized air blows it like a person blows a party blower. The sudden stretch of the air expander made of soft material may or may not hit the deer directly, but it will definitely cause a shocking effect to the deer before the garden flowers being consumed by the deer and consequently scares deer away, this shocking effect is especially amplified when the animals are nervous right after being warned by the ultrasound waves.

The pressurized air flow can be supplied by a mini container with pressurized air. However, the temperature variation in outdoor environment may cause the pressure in a full charged air container vary in a relatively dangerous range. In present embodiment the air pump 6, powered by the battery 7, is used to pump air to blow the air expander. Due to limited cavity space, only small battery can be used and such limitation leads to the need to avoid too frequent replacement of battery and consequently a rechargeable battery, charged by solar panel 12 is a better choice for the power system. Another possibility is to draw power directly from the low voltage outdoor power supply (usually 12 volt). However, since most of outdoor power supplies for garden lighting are controlled by an additional timer to limit available power to certain hours, one need to draw the power to avoid being limited by the timer.

In our test, a flow rate about 20 liters per minute with an exhaust pressure of 100 kPa will be enough to blow a party blower similar to blowing by using human's mouth. This pressure-flow combination looks like an easy requirement, but it is not true considering that we must draw power from small batteries such as C or D size battery or small pack of AA or AAA batteries.

If the air flow is large enough, a design with two or more air expanders obviously will create even more deterring power to the approaching animals. The two expanders can preferably be installed at the same height extruding out of the major stem 4 and separated by an angle of, say, 30 degree from each other. By alternatively blowing them in sequence, the scaring effect will be greatly increased. However, due to the difficulty in providing air flow large enough for two expanders and the cost consideration, one can use same expander to blow two or three time in row to increase the deterring ability.

The air expander is usually made of soft, nonporous material which is easy to stretch and exert no harm to people and animals. One can easily buy whole bag of party blowers from department stores or toy stores and they are usable in the present invention. However, to sustain outdoor harsh weather condition, product using water proof material is greatly preferred.

Ground stake 8, similar to those being used for solar lamps, can be used to support the whole repellent device.

It is always more flexible if the orientation of the sensor can be freely adjusted. However, since we are aiming to protect a small area such as small garden, the sensor can be fixed to a frame without hurting the detecting function. Similarly, the sensitivity can be fixed at a certain value to save product cost without hurting the detection of approaching animals.

It is well known that some specific frequencies or their combination are more effective in driving specific animal away. The frequencies for the ultrasound waves in current implementation, however, are not those specific to deterring deer or other animal. For the purpose of giving pre-warning signal to approaching animals, any frequency in the range of ultrasound will serve the purpose; the only requirement is that a minimum sound level such as 90 db in the neighborhood of the device is assumed. To avoid being monotonic, multiple frequencies are used.

In addition to deterring animals from small garden, current invention can also be used to gradually drive tough animals such as groundhog away from its underground cavity. Everybody knows that groundhog is an animal not easy to deal with. Ultrasound and air expander will definitely not scare it immediately. But if the device is installed around the cavity for some period and it works every time when groundhog shows up near the device, long term bothering to the groundhog is really some kind therapy to force him away eventually. Other applications such as modifying the device to be Halloween toy and neighbor dog deterring device etc. all are possible.

With respect to the above description then, it is to be realized that the optimum relationships for the parts of the invention, which including variations in size, materials, shape, form, function and manners of operation, assembly and use, are deemed readily apparent and obvious to one skilled in the art, and all equivalent relationships to those illustrated in the drawing and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An apparatus for repelling animals in a small garden comprising: a main body; a motion detector installed in said main body for detecting approaching animals; an ultrasound generating device; an air expander; a pressurized air source; a control circuit; a low voltage power source providing required electrical energy; and a device for supporting said main body standing on the ground.

2. The apparatus according to claim 1, wherein said control circuit controls the sequential operations of ultrasound generation and the charging operation of pressurized air source into said air expander.

3. The apparatus according to claim 2, wherein said sequential operations begin with ultrasound generation and end with the stopping of air charging operation.

4. The apparatus according to claim 1, wherein said air expander is made of non-hurting soft material.

5. The apparatus according to claim 1, wherein said air expander is capable of expanding to a predetermined length during air charging operation and retractable to a predetermined original length when air charging is not in operation.

6. A method for repelling animals in a small garden comprising the steps of: detecting approach of animals using a motion detector; generating ultrasound waves of multi-frequencies to annoy animals; and expanding an air expander suddenly to scare animals following said step of generating ultrasound waves.

7. The method according to claim 6, wherein said step of expanding an air expander further comprising the step of charging air into said air expander.

8. The method according to claim 6, wherein said step of generating ultrasound waves and said step of expanding an air expander form sequential operations intermediated with predetermined time period; said sequential operations are controlled by a control circuit.

9. The method according to claim 8, wherein said sequential operations begin with ultrasound generation and end with stopping air charging operation.

10. The method according to claim 6, wherein said air expander is made of non-hurting soft material.

11. The method according to claim 6, wherein said air expander is capable of expanding to a predetermined length during the air charging operation and retractable to a predetermined original length when the air charging is not in operation.
